(19) United States
(12) Patent Application Publication
(10) Pub. No.: US 2026/0257163 A1
(43) Pub. Date: Sep. 3, 2026

(54) CONVECTIVE-DRIVEN SYSTEM FOR CO2 CAPTURE

(71) Applicant: NUOVO PIGNONE TECNOLOGIE -S.R.L., Florence (IT)

(72) Inventors: Vittorio MICHELASSI, Florence (IT); Marco LISTORTI, Florence (IT)

(21) Appl. No.: 19/155,808

(22) PCT Filed: Feb. 12, 2024
(86) PCT No.: PCT/EP2024/025075

§ 371 Date: Aug. 12, 2025

(30) Foreign Application Priority Data
Feb. 17, 2023 (IT) 102023000002715

(51) Int. Cl. B01D 53/04

(52) U.S. Cl. CPC B01D 53/0423; B01D 53/0438; B01D 53/0446; B01D 2253/108; B01D 2253/204; B01D 2257/504; B01D 2258/06

(57) ABSTRACT

A system for CO2 capture from atmosphere comprising a capturing tower provided with solar energy ab-sorbing elements which are configured to be heated by solar irradiation. The capturing tower has at least one inlet at the bottom of the capturing tower and an outlet at the top of the capturing tower, which are fluidly coupled in order to define a flow path into the capturing tower in which air can flow. The system further comprises a solid filter package arranged along the flow path of the capturing tower and configured to perform CO2 capture and a heat exchange circuit configured to circulate a heat transfer fluid. The capturing tower is configured to push air along the flow path from the at least one inlet to the outlet by natural convection, transferring heat from the solar energy absorbing elements.

### TECHNICAL FIELD

The subject-matter disclosed herein relates to a system for CO2 capture from atmosphere.

### BACKGROUND ART

Nowadays, worldwide general purpose is to reduce CO2 emissions (ideally reaching net zero CO2 emissions) in order to limit global warming and preserve a livable planet. Net zero CO2 emissions (referred also as “carbon neutrality”) are achieved when anthropogenic CO2 emissions (i.e. CO2 emissions originating from human activity) are balanced globally by anthropogenic CO2 removals (i.e. CO2 removals performed by human activity) over a specified period. In general, there are known two different methods for CO2 capture: direct air capture (=DAC), which is a process of capturing carbon dioxide directly from the ambient air, or carbon capture and storage (=CCS), which is a process of capturing carbon dioxide before it enters the atmosphere (for example from point-source such as chemical plant or biomass power plant or carbon power plant), transporting it, and storing it.

Typically, direct air capture is performed through mechanical ventilation systems, having large fans to push ambient air through a filter package where CO2 is trapped. Therefore, known direct air capture systems require electrical power to work, in particular to drive the fans of the ventilation systems. Moreover, it is also to be noted that known direct air capture systems require much greater energy input (i.e. electrical power supply) in comparison to traditional capture from point sources, like flue gas from plants, due to the low concentration of CO2 in ambient air.

Therefore, it would be desirable to have a direct air capture system with limited energy input request, in particular with zero energy input request.

### SUMMARY

According to an aspect, the subject-matter disclosed herein relates to a system for CO2 capture from atmosphere comprising a capturing tower provided with solar energy absorbing elements which are configured to be heated by solar irradiation. The capturing tower has at least one inlet at the bottom of the capturing tower and an outlet at the top of the capturing tower which are fluidly coupled in order to define a flow path into the capturing tower in which air can flow. The system further comprises a solid filter package arranged along the flow path of the capturing tower and configured to perform CO2 capture and a heat exchange circuit configured to circulate a heat transfer fluid. The capturing tower is configured to push air along the flow path from the at least one inlet to the outlet by natural convection, transferring heat from the solar energy absorbing elements to air along the flow path and transferring heat from the heat transfer fluid to air along the flow path.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a schematic cross-sectional view of a first embodiment of an innovative CO2 capture system comprising a capturing tower,

FIG. 2 shows a schematic cross-sectional view of the capturing tower of FIG. 1 in which dimensional references are highlighted, and

FIG. 3 shows a schematic and partial view of an example of lateral wall provided with heat exchanger circuit.

### DETAILED DESCRIPTION OF EMBODIMENTS

According to an aspect, the subject-matter disclosed herein relates to an innovative CO2 capture system for capturing CO2 from atmosphere. The system works by moving air by natural convection from bottom to top of a suitable tower in which solid filters for CO2 capture are located. The walls of the tower are configured to be heated by solar irradiation (advantageously the walls may also store heat due to its thermal capacity) and to transfer heat to the air flowing in the tower so that, due to thermal gradient, air is pushed by natural convection from bottom to top of the tower. Therefore, air from atmosphere enters from the bottom of the tower, flows into the tower through solid filters that capture CO2 and then purified air is released back to atmosphere from the top of the tower.

Reference now will be made in detail to embodiments of the disclosure, examples of which are illustrated in the drawings. The examples and drawing figures are provided by way of explanation of the disclosure and should not be construed as a limitation of the disclosure. In fact, it will be apparent to those skilled in the art that various modifications and variations can be made in the present disclosure without departing from the scope or spirit of the disclosure. In the following description, similar reference numerals are used for the illustration of figures of the embodiments to indicate elements performing the same or similar functions. Moreover, for clarity of illustration, some references may be not repeated in all the figures.

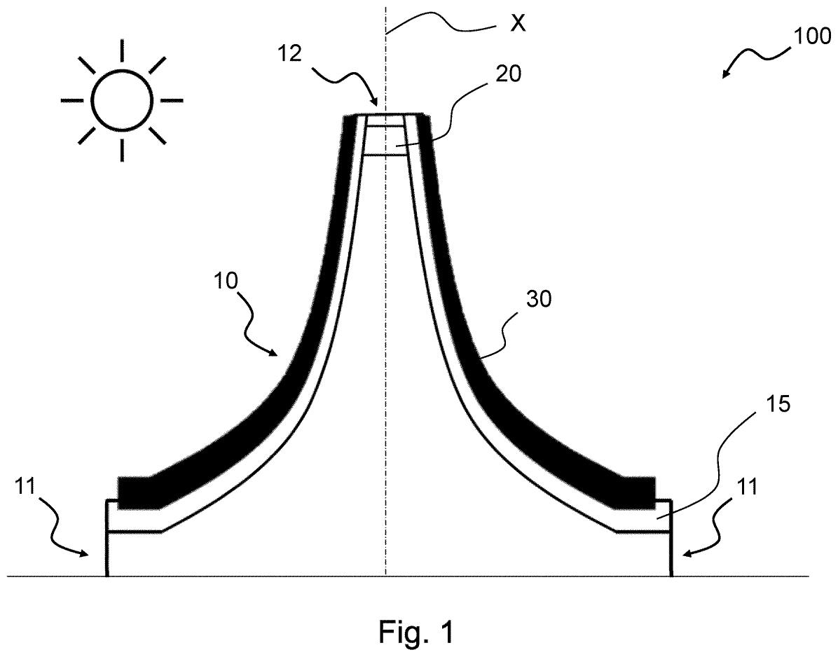

FIG. 1 shows a simplified cross-sectional view of a first embodiment of an innovative system 100 for CO2 capture, referred in the following as “system 100”. With non-limiting reference to FIG. 1, the system 100 comprises a capturing tower 10 which has at least one inlet 11 at the bottom of the capturing tower and an outlet 12 at the top of the capturing tower. The at least one inlet 11 and the outlet 12 are fluidly coupled in order to define a flow path into the capturing tower 10. In particular, the least one inlet 11 is configured to suck air from atmosphere into the capturing tower 10 and the outlet 11 is configured to discharge air, in particular—as it will be apparent from the following—purified air, back to atmosphere. It is to be noted that, for the purpose of the present disclosure, “purified air” means air with low concentration (possibly zero concentration) of CO2, in particular with respect to CO2 concentration of air sucked from the at least one inlet 11. It is also to be noted that the capturing tower 10 may further comprises one or more guiding septa along the flow path configured to guide the air which flows, in particular to optimize pressure drops due to air flowing.

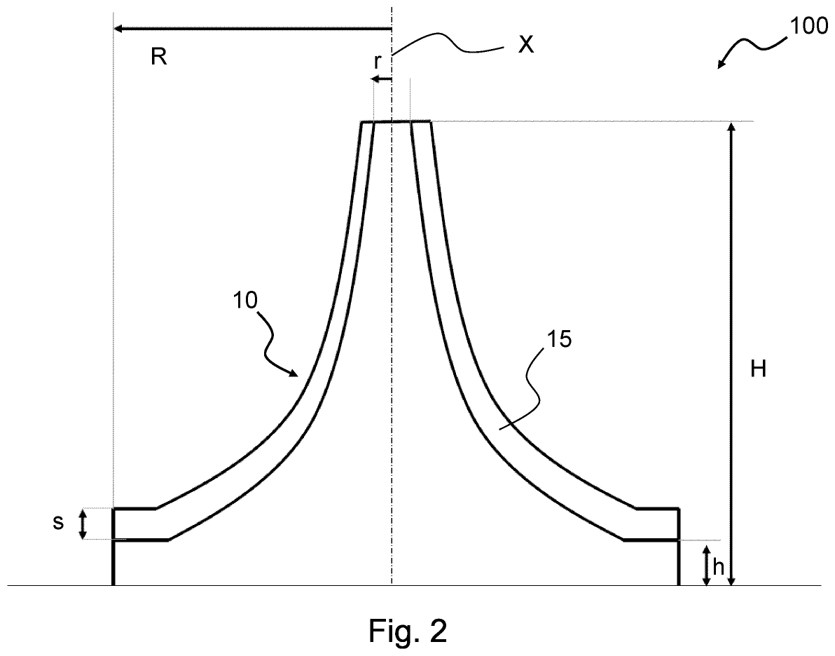

An example of capturing tower 10 it will be described in the following with the aid of FIG. 2. FIG. 2 show a schematic cross-sectional view of the embodiment of the capturing tower shown in FIG. 1 in which dimensional references are highlighted. Advantageously, the capturing tower 10 can be intended as a solid of revolution obtained by rotating a plane profile (which will be better described in the following) around a revolution axis. With non-limiting reference to FIG. 2, the capturing tower 10 comprises a lateral wall 15 which develops around the axis X. It is to be noted that the lateral wall 15 defines a continuous surface around the axis X. Advantageously, the lateral wall 15 defines also the inlet 11 as a continuous inlet surface, in particular a cylindrical inlet surface, around the axis X (see the reference “h” in FIG. 2). Advantageously, the lateral wall 15 defines also the outlet 11 as a continuous outlet surface, in particular a circular outlet surface, around the axis X.

It is also to be noted that the lateral wall 15 has substantially a vertical development along the axis X; in other words, the vertical development of capturing tower 10 is much greater than the horizontal development of the capturing tower 10. In particular, the vertical development of the capturing tower 10 (see reference “H” in FIG. 2) may be greater than 20 meters (m), while the horizontal development of the capturing tower 10 starting from the axis X (see reference “R” in FIG. 2) may be for example ⅓ of the vertical development. It is to be noted that the horizontal development of the capturing tower 10 may vary along the axis X; in particular may decrease from the bottom to the top of the capturing tower 10. With non-limiting reference to FIG. 2, the horizontal development R at the bottom of the capturing tower 10 (i.e. at the ground, see axis Y in FIG. 2) may be much greater than the horizontal development at the top of the capturing tower 10 (see reference “r” in FIG. 2). It is also to be noted that the thickness of the lateral wall 15 (see reference “s” in FIG. 2) may vary along the axis X, from the bottom to the top of the capturing tower 10.

It is to be noted that the sizing of the capturing tower 10 is a design choice depending in particular on the goal to be achieved (for example irradiation requirements, CO2 capture efficiency, heat transfer efficiency . . . ) . For example, the natural convection efficiency depends on the height H of the capturing tower 10 and on the surface of the lateral wall 15 exposed to solar irradiation, while the air differential pressure between the inlet 11 and the outlet 12 (not considering the pressure drop due to the CO2 capture, in particular due to the air flowing through a CO2 capture filter system, as it will be better described in the following) depends on the ratio between the surface of the inlet 11 and the surface of the lateral wall 15 configured to transfer heat to the air flowing through the capturing tower 10. Therefore, it will be apparent for the person skilled in the art that the sizing of a suitable capturing tower may be obtained easily for example by performing a numerical simulation or experimentation according to specific requirements or constraints, such as structural constraints and/or CO2 capture efficiency and/or heat transfer efficiency.

Advantageously, in order to maximize the surface of the lateral wall 15 exposed to solar irradiation (in particular taking into account that the position of the sun varies according to seasons and to the time of day), the lateral wall 15, in particular the cross-section of the lateral wall 15, has a hyperbola arc shape or clothoid arc shape or an exponential function arc shape.

In order to perform CO2 capture, the system 100 comprises further a solid filter package 20 arranged along the flow path of the capturing tower 10, in particular between the inlet 11 and the outlet 12 of the capturing tower 10. Advantageously, the solid filter package is made of solid sorbents which may include one or more of porous, solid-phase materials, such as zeolites or metal organic frame works (MOFs); however, other similar materials may be used. Advantageously, the solid filter package 20 is located at the outlet 12, in particular upstream the outlet 12. It is to be noted that the location of the solid filter package 20 at the outlet 12 is particularly advantageous in order to optimize both the pressure drop across the solid filter package 20 and the heat exchange between the capturing tower 10 and the air. In particular, this location allows for the best trade-off between the section of the solid filter package 20 in which the air flows through and the amount of air which can exchange heat efficiently with the lateral wall 15 (in fact, if the solid filter package 20 will be located closer to the inlet 11, the section of the solid filter package 20 in which the air flows through will be greater and will be greater also the amount of air which flows furthest from the lateral wall 15).

As stated before, the system 100 is configured to push air by natural convection along the flow path from the inlet 11 to the outlet 12 of the capturing tower 10. The capturing tower 10 comprises solar energy absorbing elements 30 which are configured to be heated by solar irradiation. The solar energy absorbing elements 30 transfer heat to air along the flow path so that, due to thermal gradient, air is pushed by natural convection from bottom to top of the capturing tower 10. It is to be noted that, as it will be better described in the following, the capturing tower 10 may also be configured to transfer heat to the air even if solar irradiation at a certain moment is not present and/or if solar irradiation at a certain moment is not enough to supply the amount of heat requested to ensure the flow of air through the capturing tower 10.

According to a possibility, the solar energy absorbing elements 30 are located on an external surface of the lateral wall 15. For example, the solar energy absorbing elements 30 may be in the form of a layer of radiation-absorbent material, in particular a suitable paint covering the lateral wall 15, which is configured to optimize the solar irradiation absorbing.

According to another possibility, the solar energy absorbing elements 30 are integrated with the lateral wall 15. For example, the solar energy absorbing elements 30 may be in the form of a suitable material from which the lateral wall 15 is made or a suitable material integrated into the building material of the lateral wall 15.

For example, the lateral wall 15 may be made of reinforced concrete, such as the evaporative towers of stream plants. According to a possibility, the reinforced concrete may be covered by a thin layer of radiation-absorbent material. According to another possibility, the reinforced concrete may comprise a metal shell. Advantageously, the metal shell may also comprise tube bundles in which diathermic fluid may flow, in order to increase thermal inertia and optimize heat exchange.

Advantageously, the capturing tower 10 further comprises a heat exchange circuit configured to circulate a heat transfer fluid, for example a coil system in which a heat transfer fluid may flow (such as water or a diathermic fluid). In particular, the heat exchange circuit is configured to transfer heat from the heat transfer fluid to air along the flow path. It is to be noted that the heat transfer fluid may be heated by solar irradiation or may be heated by an external heat source, for example a geothermal plant or a waste heat source from an industrial process or plant or a power plant, in particular a renewable power plant. In particular, the heat transfer fluid may directly receive heat from solar irradiation (i.e. being exposed to solar irradiation) or may indirectly receive heat from solar irradiation, for example may receive heat from the solar energy absorbing elements 30.

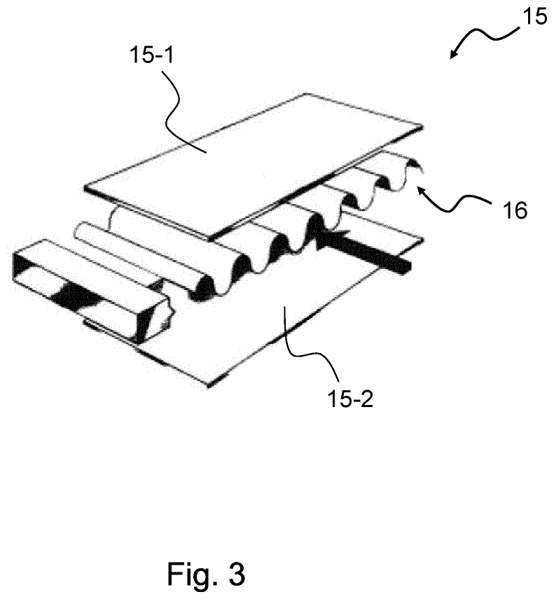

In FIG. 3 there is shown for example and without limitation a possible configuration of the lateral wall 15 provided with a heat exchange circuit. In particular, FIG. 3 shows a wafer arrangement of the heat exchange circuit embedded into the lateral wall 15: the heat exchange circuit comprises a corrugated plate 16 located between an external lateral wall 15-1 and an internal lateral wall 15-2 of the capturing tower 10. The corrugated plate 16 is configured to circulate a heat transfer fluid (which, as stated before, could be water or a diathermic fluid or other suitable heat transfer fluid, see the big black arrow in FIG. 3) in order to perform heat exchange between air and heat transfer fluid (i.e. transferring heat from the heat transfer fluid to air) along the flow path of the air flowing inside the capturing tower 10 and so to push air along the flow path from the inlet 11 to the outlet 12 of the capturing tower 10. It is to be noted that the configuration shown in FIG. 3 is particularly advantageous to optimize the structure resistance of the capturing tower 10 and the heat exchange between the heat transfer fluid and the air.

Accorded to another possibility, not shown in any figures, the heat exchange circuit may comprise a piping system, in particular a coil system, which may be located on the external surface of the lateral wall 15 or, alternatively, on the internal surface of the lateral wall 15. The piping system is configured to circulate a heat transfer fluid (which, as stated before, could be water or a diathermic fluid or other suitable heat transfer fluid) in order to perform heat exchange between air and heat transfer fluid (i.e. transferring heat from the heat transfer fluid to air) along the flow path of the air flowing inside the capturing tower 10 and so to push air along the flow path from the inlet 11 to the outlet 12 of the capturing tower 10.

As mentioned above, according to a first possibility, the heat transfer circuit may be fluidly coupled to additional solar thermal panels, located elsewhere (i.e. not on the surface of the capturing tower 10) to maximize the solar irradiated surface. In particular, the heat transfer fluid circulating in the heat exchange circuit is heated up through solar thermal panels, flows into the wafer arrangement or piping system of the heat exchange circuit transferring heat to air flowing into the capturing tower 10 (cooling in turn) and then is recirculated back to the solar thermal panels.

As mentioned above, according to a second possibility, the heat transfer circuit may be fluidly coupled to an external heat source, for example a geothermal plant or a waste heat source from an industrial process or plant or a power plant, in particular a renewable power plant, or traditional heat generation devices (such as electric resistances, heat pumps . . . ) . In particular, the heat transfer fluid circulating in the heat exchange circuit is heated up through the external heat source, flows into the wafer arrangement or piping system of the heat exchange circuit transferring heat to air flowing into the capturing tower 10 (cooling in turn) and then is recirculated back to the external heat source.

1. A system for CO2 capture from atmosphere comprising:
a capturing tower having an axis and comprising a lateral wall having substantially vertical development along the axis, and
a solid filter package configured to perform CO2 capture;
wherein the capturing tower comprises at least one inlet at the bottom of the capturing tower and an outlet at the top of the capturing tower, said at least one inlet and said outlet being fluidly coupled in order to define a flow path into the capturing tower;
a heat exchange circuit configured to circulate a heat transfer fluid;
wherein the solid filter package is arranged along the flow path of the capturing tower;
wherein the capturing tower comprises solar energy absorbing elements configured to be heated by solar irradiation,
wherein the capturing tower is configured to push air along the flow path from the at least one inlet to the outlet by transferring heat from the solar energy absorbing elements to air along the flow path, and
wherein the heat exchange circuit is configured to push air along the flow path from the at least one inlet to the outlet by transferring heat from the heat transfer fluid to air along the flow path.

2. The system for CO2 capture of claim 1, wherein the lateral wall has a hyperbola arc shape or clothoid arc shape or an exponential function arc shape.

3. The system for CO2 capture of claim 1, wherein the solar energy absorbing elements are located on an external surface of the lateral wall.

4. The system for CO2 capture of claim 1, wherein the solar energy absorbing elements are integrated with the lateral wall.

5. The system for CO2 capture of claim 1, wherein the heat transfer fluid is configured to receive heat from solar irradiation.

6. The system for CO2 capture of claim 1, wherein the heat transfer fluid is configured to receive heat from an external heat source.

7. The system for CO2 capture of claim 1, wherein the solid filter package is arranged at the outlet of the capturing tower.

8. The system for CO2 capture of claim 1, wherein the capturing tower further comprises one or more guiding septa configured to guide the air flowing along the flow path.
